(19) United States
(12) Patent Application Publication
(10) Pub. No.: US 2019/0019258 A1
(43) Pub. Date: Jan. 17, 2019

(54) AGGREGATING MEMBER FEATURES INTO COMPANY-LEVEL INSIGHTS FOR DATA ANALYTICS

(71) Applicant: LinkedIn Corporation, Sunnyvale, CA (US)

(72) Inventors: Songtao Guo, Cupertino, CA (US); Wei Di, Cupertino, CA (US); Juan Wang, Los Altos, CA (US)

(73) Assignee: LinkedIn Corporation, Sunnyvale, CA (US)

(21) Appl. No.: 15/648,236

(22) Filed: Jul. 12, 2017

(51) Int. Cl. G06Q 50/00; G06F 17/30; G06Q 10/06

(52) U.S. Cl. CPC G06Q 50/01; G06Q 10/063; G06F 17/3089

(57) ABSTRACT

The disclosed embodiments provide a system for processing data. During operation, the system obtains member features for members of a social network, wherein the member features include a company. The system also obtains a definition of a member segment, wherein the definition includes one or more of the member features. Next, the system identifies a subset of the members for inclusion in the member segment using the one or more of the member features. The system then aggregates the member features by the company to generate a set of company features for the company and aggregates the company features by the member segment to generate additional company features for inclusion in the set of company features. Finally, the system outputs the company features for use in processing queries related to the company.

### BACKGROUND

### Field

The disclosed embodiments relate to data analysis. More specifically, the disclosed embodiments relate to techniques for aggregating member features into company-level insights for data analytics.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

However, significant increases in the size of data sets have resulted in difficulties associated with collecting, storing, managing, transferring, sharing, analyzing, and/or visualizing the data in a timely manner. For example, conventional software tools and/or storage mechanisms may be unable to handle petabytes or exabytes of loosely structured data that is generated on a daily and/or continuous basis from multiple, heterogeneous sources. Instead, management and processing of “big data” may require massively parallel software running on a large number of physical servers and/or nodes, as well as synchronization among the servers and/or nodes.

Consequently, big data analytics may be facilitated by mechanisms for efficiently and/or effectively collecting, storing, managing, compressing, aggregating, transferring, sharing, analyzing, and/or visualizing large data sets.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

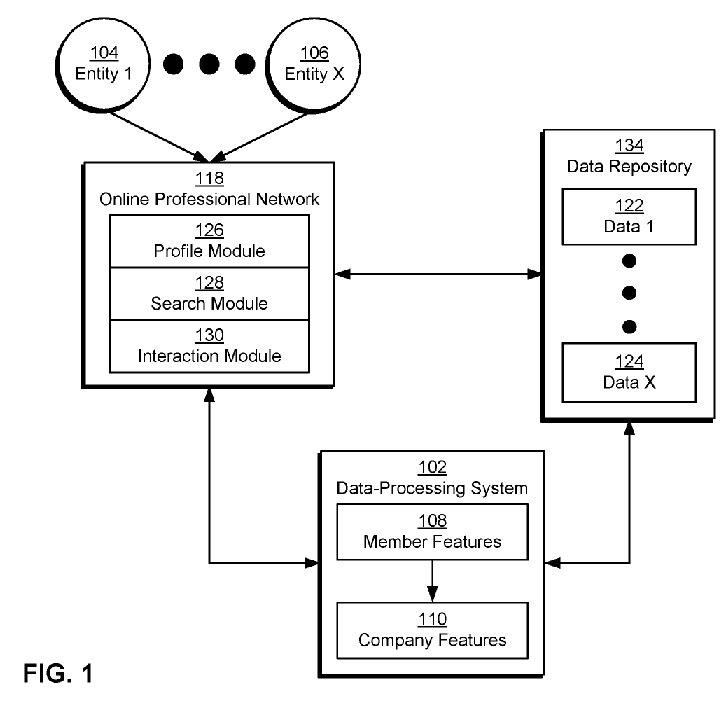

The disclosed provide a method, apparatus, and system for processing data related to a social network or other community of users. As shown in FIG. 1, the social network may include an online professional network 118 that is used by a set of entities (e.g., entity 1 104, entity x 106) to interact with one another in a professional, social, and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in the online professional network.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature of the online professional network to search for profiles, jobs, and/or information by categories such as first name, last name, title, company, school, location, interests, relationship, industry, groups, salary, experience level, etc.

The entities may also use an interaction module 130 to interact with other entities in online professional network 118. For example, interaction module 130 may allow an entity to add other entities as connections, follow other entities, send and receive messages with other entities, join groups, and/or interact with (e.g., create, share, re-share, like, and/or comment on) posts from other entities. Interaction module 130 may also allow the entity to upload and/or link an address book or contact list to facilitate connections, follows, messaging, and/or other types of interactions with the entity's external contacts.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. Examples of data that may be stored include, but are not limited to, profile updates, profile views, connections, endorsements, invitations, follows, posts, comments, likes, shares, searches, clicks, messages, interactions with groups, address book interactions, response to recommendations, purchases, and/or other actions performed by entities in online professional network 118. Such data and/or activities may be tracked and stored in a database, data warehouse, cloud storage, and/or other data-storage mechanism providing data repository 134.

In turn, the data may be analyzed to discover relationships, patterns, and/or trends in the data; gain insights from the input data; and/or guide decisions or actions related to the data. For example, statistical models may be applied to data in data repository 134 to generate scores, classifications, recommendations, estimates, predictions, and/or other inferences or properties.

The output may be inferred or extracted from primary features in the input data and/or derived features that are generated from primary features and/or other derived features. For example, the primary features may include profile data, user activity, and/or other data that is extracted directly from fields or records in online professional network 118. The primary features may be aggregated, scaled, combined, bucketized, and/or otherwise transformed to produce derived features, which in turn may be further combined or transformed with one another and/or the primary features to generate additional derived features. After output is generated from one or more sets of primary and/or derived features, the output may be queried and/or used to improve revenue, interaction with the users and/or organizations, use of the applications and/or content, and/or other metrics associated with the input data.

In one or more embodiments, the system of FIG. 1 includes functionality to improve modeling and/or analysis of data in data repository 134 by aggregating member features 108 for members of online professional network 118 into company features 110 for companies at which the members are employed. Member features 108 may include profile attributes from the members' profiles with online professional network 118, such as each member's title, skills, work experience, education, seniority, industry, location, and/or profile completeness. Member features 108 may also include each member's number of connections in the social network, the member's tenure on the social network, and/or other metrics related to the member's overall interaction or “footprint” in online professional network 118. The member features may further include attributes that are specific to one or more features of online professional network 118, such as a classification of the member as a job seeker or non-job-seeker.

Member features 108 may also characterize the activity of the members with online professional network 118. For example, the member features may include an activity level of each member, which may be binary (e.g., dormant or active) or calculated by aggregating different types of activities into an overall activity count and/or a bucketized activity score. The activity features may also include attributes (e.g., activity frequency, dormancy, total number of user actions, average number of user actions, etc.) related to specific types of social network activity, such as messaging activity (e.g., sending messages within the social network), publishing activity (e.g., publishing posts or articles in the social network), mobile activity (e.g., accessing the social network through a mobile device), and/or email activity (e.g., accessing the social network through email or email notifications).

As discussed in further detail below, a data-processing system 102 may obtain member features 108 from data repository 134 and group member features 108 by member segment, company, and/or activity type. Data-processing system 102 may then aggregate numeric features, binary features, and/or recency features in the grouped member features 108 into counts, sums, averages, ratios, medians, and/or other statistics or metrics and store the aggregated features in company features 110 within data repository 134. For example, company features 110 may include measures of aggregated user activity for specific activity types (e.g., profile views, page views, jobs, searches, purchases, endorsements, messaging, content views, invitations, connections, recommendations, advertisements, etc.), member segments, and companies. In turn, company features 110 may be used to glean company-level insights or trends from member-level online professional network 118 data, perform statistical modeling at the company and/or member segment level, and/or guide decisions related to business-to-business (B2B) marketing or sales activities.

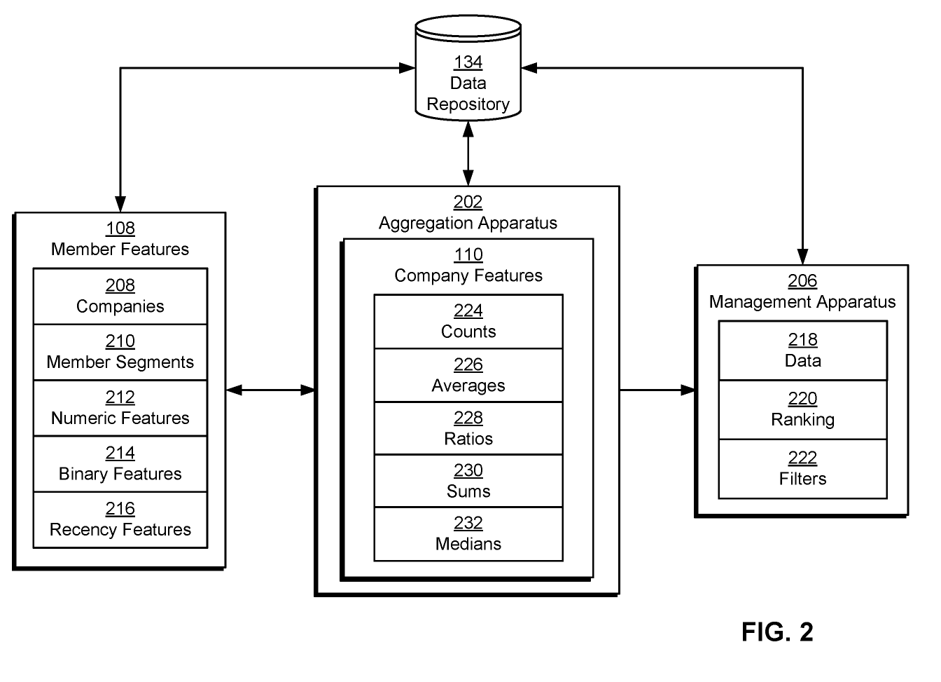

FIG. 2 shows a system for processing data, such as data-processing system 102 of FIG. 1, in accordance with the disclosed embodiments. As shown in FIG. 2, the system includes an aggregation apparatus 202 and a management apparatus 206. Each of these components is described in further detail below.

Aggregation apparatus 202 may obtain member features 108 from data repository 134 and/or another data store. Alternatively, aggregation apparatus 202 and/or another component of the system may periodically generate a portion of member features 108 from other features or raw data in data repository 134. For example, the component may aggregate and/or transform records of user activity and/or user profile data on a social network (e.g., online professional network 118 of FIG. 1) into member features 108 on a daily, weekly, biweekly, and/or monthly basis. The component may optionally produce a portion of member features 108 when a pre-specified number of records has been received and/or in response to another trigger, such as user input.

Member features 108 may include a set of companies 208, a set of member segments 210, a set of numeric features 212, a set of binary features 214, and a set of recency features 216. Companies 208 may include and/or identify for-profit, non-profit, educational, enterprise, medium-sized, small-business, and/or other organizations at which members associated with member features 108 are or were employed. For example, a unique identifier (ID) for a company may be linked to and/or stored with numeric features 212, binary features 214, and/or recency features 216 for each member that is an employee of the company. To add IDs for companies 208 to member features 108, member IDs from feature sets containing numeric features 212, binary features 214, and/or recency features 216 may be mapped to company IDs for companies listed as the member's employers in profile data for the members, and the company IDs may be included in one or more fields of the feature sets.

Member segments 210 may include groups of members that share one or more common attributes. For example, member segments 210 in the social network may be defined to include members with the same industry, location, level of seniority, and/or language. In turn, the members may be targeted and/or reached based on shared needs, preferences, interests, lifestyles, and/or demographic attributes in the corresponding member segments 210. As a result, attributes common to members in a given member segment may be selected based on the relevance of the attributes to features of the social network and/or products offered by or through the social network.

In one or more embodiments, member segments 210 represent all employees in a company and/or specific types of employees, such as recruiters, recruiter seats, talent professionals, core sales roles, sales-related roles, and/or decision makers. Each member segment may be defined by one or more member features 108. For example, all employees in a company may be identified as a set of members that have an employer represented by a company ID for the company. In a second example, recruiters may be identified by attributes related to employment at a staffing company, high levels of job-posting activity, and/or job titles or other profile attributes with keywords related to recruiting. In a third example, recruiter seats may be identified as members with access to or a subscription with a recruiting solution offered by or through the social network. In a fourth example, talent professionals may be defined as members with job titles and/or other profile attributes related to recruiting, hiring, sourcing, human resources, staffing, and/or other activity related to hiring talent for a company. In a fifth example, core sales roles may be identified as members with job titles and/or other profile attributes related to sales activities. In a sixth example, sales-related roles may be defined as members with profile attributes that list membership in sales-related groups, sales-related industries, and/or endorsements of sales-related skills. In a seventh example, decision makers may include members with high levels of seniority and/or job titles such as “vice president,” “director,” “executive,” and/or “owner.”

Like companies 208, member segments 210 may be added to member features 108 by mapping attributes in member features 108 to the corresponding member segments 210. For example, a unique identifier (ID) for a member segment may be linked to and/or stored with numeric features 212, binary features 214, and/or recency features 216 for each member in the member segment.

Numeric features 212 may store numeric values related to attributes or activity of the members. For example, numeric features 212 may track each member's views of specific pages, groups of pages (e.g., jobs pages, account registration pages, messaging pages, recommendation pages, profile pages, etc.), total number of page views, and/or daily page views over a given period (e.g., a week, a month, etc.). Similar numeric features 212 may also be used to track the member's level of activity with respect to job applications, searches, and/or views; address book uploads, contact imports, and/or appearances in address book uploads; creating an account with the social network; logging into the social network; clicks or views of advertisements; connection requests sent, received, accepted, or rejected; emails received, opened, and/or clicked; a conversion or subscription funnel; federated, content, or job searches; interaction with content items in a content feed; messages sent or received; and/or job or connection recommendations. In another example, numeric features 212 may include connection scores, reputation scores, propensity scores, and/or other scores calculated from other features associated with the members.

Binary features 214 may include Boolean values of 1 and 0 that indicate if a corresponding attribute is true or false. For example, binary features 214 may specify if a member is active or inactive with respect to page views, profile views, job-seeking activity, address book uploads, connection requests, advertisements, products, content, searches, and/or other types of activity within or outside the social network. The member may be classified as active if the member has had any activity of that activity type within a given period (e.g., a week) and inactive otherwise.

Recency features 216 may represent the recency of data used to populate other features (e.g., companies 208, member segments 210, numeric features 212, binary features 214). For example, each set of member features 108 may include a record containing a set of recency features 216 for each member.

The record may include a member ID for the member, a timestamp representing the date at which the record and/or feature set was generated, and a set of recencies for the member's participation in various types of activities (e.g., subscription funnel, job applications, job searches, job views, social network activity). Each recency value may be calculated by subtracting the timestamp of the member's last action for a certain activity type (e.g., searching for jobs, viewing jobs, accessing the social network, browsing products offered for purchase, interacting with a subscription funnel for a product, etc.) from the timestamp representing the date at which the record and/or feature set was generated. Thus, the recency value may be higher if more time has elapsed since the member last participated in the corresponding type of activity and lower if less time has elapsed since the member last participated in the corresponding type of activity.

As shown in FIG. 2, aggregation apparatus 202 may aggregate member features 108 into counts 224, averages 226, ratios 228, sums 230, and/or medians 232 in company features 110. Such aggregation may be performed over a time interval that is equal to or longer than the time interval used to generate member features 108. For example, member features 108 may be produced from raw events and/or records of user activity on a weekly basis, while company features 110 may be generated from member features 108 on a biweekly or monthly basis. In other words, multiple sets of member features 108 in data repository 134 may be used to produce a single set of company features 110.

More specifically, aggregation apparatus 202 may aggregate numeric features 212, binary features 214, and recency features 216 by companies 208 and member segments 210 into different combinations of statistical values in company features 110. First, aggregation apparatus 202 may aggregate numeric features 212 into counts 224, averages 226, ratios 228, sums 230, and medians 232. For example, values of page views, grouped page views, daily page views, and/or total page views for members in a given member segment and employed by a given company may be aggregated on a weekly basis into a count of active members with respect to page view activity (e.g., members with any page views in that week) for the company and member segment. All unique member IDs in the company and member segment may also be aggregated into a total count of all members for that company and member segment. The count of active members may then be divided by the total count to produce a ratio of active to total members for the company and member segment. Values of numeric features 212 may also be used to produce a set of sums 230, such as sums of all page views by members in the member segment and company for a given page, group of pages, day, and/or week. The values may further be used to produce a first set of averages 226 as the sums divided by the total number of members in the member segment and company, as well as a second set of averages 226 as the sums divided by the count of active members in the member segment and company. Finally, a median value may be produced from page views for a given page, group of pages, day, and/or week.

Second, aggregation apparatus 202 may aggregate binary features 214 into counts 224, averages 226, and ratios 228. Continuing with the previous example, binary features 214 related to page views in a given member segment and company may be aggregated into the same count of active members, total count of all members, and ratio of active to total members as those of numeric features 212. All positive (e.g., true) values in binary features 214 may also be used to generate sums 230 representing the number of members in the company and member segment that have any page views for a given page, group of pages, day, and/or week. Sums 230 may then be divided by the count of active members and total number of members in the company and member segment to produce two sets of averages 226 representing the average number of page views for a given page, group of pages, day, and/or week. Because binary features 214 have values that are restricted to either 1 or 0, medians 232 may be omitted from company features 110 aggregated from binary features 214.

Third, aggregation apparatus 202 may aggregate recency features 216 into counts 224, averages 226, ratios 228, and medians 232. For example, company features 110 calculated from recency features 216 may include the same count of active members, total count of all members, and ratio of active to total members as those of numeric features 212 and binary features 214. On the other hand, sums 230 may be omitted from aggregations of recency features 216 into company features 110 because sums of recency values may lack meaning or significance. Instead, sums 230 may be calculated from recency features 216 and divided by the count of active members and total number of members to produce averages 226 representing average recencies for page view activity in the company and member segment. Sums 230 of recency features 216 may then be discarded once averages 226 are produced from sums 230.

After one or more sets of member features 108 are aggregated into company features 110, aggregation apparatus 202 may store company features 110 in data repository 134 and/or another data store. In turn, management apparatus 206 may output company features 110 for use in subsequent analysis and/or processing of queries.

First, management apparatus 206 may display, export, and/or otherwise output data 218 in company features 110. For example, management apparatus 206 may allow data 218 to be retrieved and/or queried by providing a path and/or name for each set of company features 110. Management apparatus 206 may also propagate data 218 into online, nearline, and/or offline processing systems for use by statistical models and/or other data analysis mechanisms in the processing systems.

Second, management apparatus 206 may generate a ranking 220 associated with data 218. For example, management apparatus 206 may order companies 208, member segments 210, and/or activity types associated with data 218 by increasing or decreasing order of counts 224, averages 226, ratios 228, sums 230, and/or medians 232.

Third, management apparatus 206 may apply one or more filters 222 to data 218 and/or ranking 220. For example, management apparatus 206 may allow users to specify, in queries of company features 110 and/or a user interface for viewing company features 110, filters related to companies 208, member segments 210, activity types, and/or aggregated statistical values in company features 110. Consequently, the system of FIG. 2 may leverage user actions and other types of data for the members to produce views and insights related to companies and member segments to which the members belong.

Those skilled in the art will appreciate that the system of FIG. 2 may be implemented in a variety of ways. First, aggregation apparatus 202, management apparatus 206, and/or data repository 134 may be provided by a single physical machine, multiple computer systems, one or more virtual machines, a grid, one or more databases, one or more filesystems, and/or a cloud computing system. Aggregation apparatus 202 and management apparatus 206 may additionally be implemented together and/or separately by one or more hardware and/or software components and/or layers.

Second, member features 108 may be aggregated into company features 110 in various ways. For example, member features 108 may include other types of features, such as timestamps, ordinal features, and/or categorical features. In another example, various types of member features 108 may be aggregated into percentiles, variances, skewnesses, kurtoses, standard deviations, correlation coefficients, cosine similarities, cross products, and/or other numeric or statistical measures. In a third example, member features 108 may be aggregated into company features 110 along dimensions such as location, groups of companies, schools attended by the members, groups to which the members belong, and/or skills of the members, in addition to or in lieu of aggregation by companies 208, member segments 210, and/or activity type. In a fourth example, member features 108 and company features 110 may be updated to reflect new activity types and/or other types of member data represented by numeric features 212, binary features 214, recency features 216, and/or other types of features.

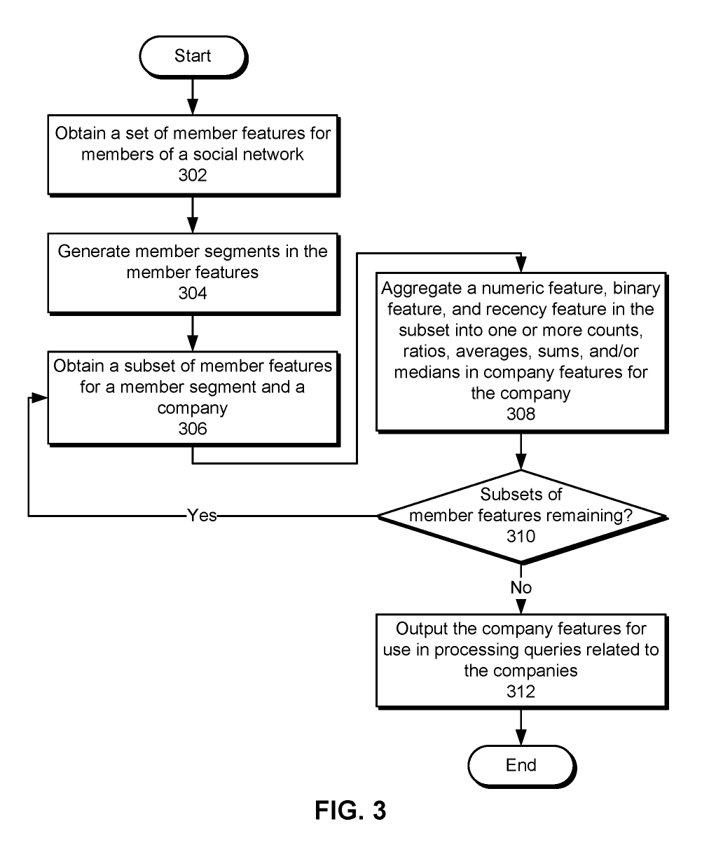

FIG. 3 shows a flowchart illustrating the processing of data in accordance with the disclosed embodiments. In one or more embodiments, one or more of the steps may be omitted, repeated, and/or performed in a different order.

Accordingly, the specific arrangement of steps shown in FIG. 3 should not be construed as limiting the scope of the embodiments.

Initially, a set of member features for members of a social network is obtained (operation 302). The member features may include a company (e.g., employer), a numeric feature, a binary feature, and/or a recency feature. The member features may be generated on a periodic (e.g., daily, weekly, biweekly, monthly, etc.) basis and/or after a pre-specified amount of user profile data or user activity data from which the member features are produced has been received.

Next, member segments in the member features are generated (operation 304). For example, profile attributes and/or other member features may be matched to member segments representing all employees of a company, recruiters, recruiter seats, talent professionals, core sales roles, sales-related roles, and/or decision makers. Profile attributes and/or member features representing a given member segment may be obtained from a definition of the member segment. The member features may also be updated with fields representing the member segments. In another example, the member features may be inputted into one or more statistical models that classify the members into a set of member segments.

A subset of member features for a given member segment and company is then obtained (operation 306). For example, the subset of member features may include, for a given member, a member identifier, company at which the member is employed, one or more member segments to which the member belongs, and one or more times at which the member was placed into the member segment(s). A numeric feature, binary feature, and recency feature in the subset is also aggregated into one or more counts, ratios, averages, sums, and/or medians in company features for the company (operation 308). For example, the numeric, binary, and/or recency features may be used to produce a count of active members in a member segment, a total count of members in the member segment, a ratio of active members to total members, a first average calculated using the count of active members, and a second average calculated using the total count of members. The member features may further be aggregated into a sum for the numeric and binary features, a median for the numeric and recency features, and/or other types of statistics. The member features may additionally be aggregated into the company features by activity types such as page views, profile views, profile updates, searches (e.g., job searches, content searches, federated searches, etc.), advertisements, content interactions (e.g., in a content feed of the social network), endorsements (e.g., of skills), connections (e.g., connections made, accepted, or rejected), new member activity (e.g., account creation, profile completion, login activity, etc.), subscription funnel activity (e.g., with products offered through the social network), jobs (e.g., job searches, job views, job applications), recommendations (e.g., recommendation views, recommendations accepted or rejected, etc.), invitations (e.g., connection invitations sent or received, invitations accepted or rejected as sender or recipient, etc.), messages, scores (e.g., propensity scores, reputation scores, connection strength scores, etc.), and/or address book activity (e.g., address book uploads, imported contacts from address books, appearances in address book uploads, etc.).

Operations 306-308 may be repeated for remaining subsets of member features (operation 310). For example, one or more sets of member features for each combination of member segment, company, and activity type may be aggregated into a set of company features. The member features may also be aggregated into the company features along a time interval that is slower than the time interval for generating the member features from raw data. Operations 306-310 may also, or instead, be performed in parallel for various member segments and/or companies associated with the members to expedite processing of member and company features.

Finally, the company features are outputted for use in processing queries related to the companies (operation 312). For example, the company features may be stored in a data store for subsequent retrieval and analysis; loaded into an online, offline, or nearline processing system; and/or displayed within a user interface. In turn, the company features may be used to perform statistical inference, time series analysis, large-scale machine learning, and/or other types of analysis on the company, member segment, and/or other levels.

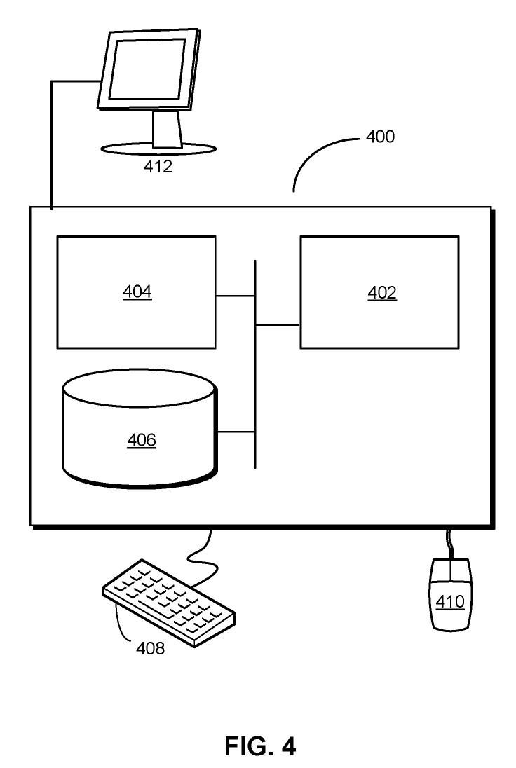

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an aggregation apparatus and a management apparatus, one or both of which may alternatively be termed or implemented as a module, mechanism, or other type of system component. The aggregation apparatus may obtain a set of member features for a set of members of a social network. The member features may include a set of member segments and a set of companies. Next, the aggregation apparatus may aggregate the member features by the member segments and the companies to generate a set of company features for the companies. The management apparatus may then output the company features for use in processing queries related to the companies.

In addition, one or more components of computer system 400 may be remotely located and connected to the other components over a network. Portions of the present embodiments (e.g., aggregation apparatus, management apparatus, data repository, etc.) may also be located on different nodes of a distributed system that implements the embodiments. For example, the present embodiments may be implemented using a cloud computing system that generates company features from member features for a set of remote members of a social network.

By configuring privacy controls or settings as they desire, members of a social network, a professional network, or other user community that may use or interact with embodiments described herein can control or restrict the information that is collected from them, the information that is provided to thein, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining member features for members of a social network, wherein the member features comprise a company;
obtaining a definition of a member segment, wherein the definition comprises one or more of the member features;
identifying a subset of the members for inclusion in the member segment using the one or more of the member features;
aggregating, by one or more computer systems, the member features by the company to generate a set of company features for the company;
aggregating, by the one or more computer systems, the company features by the member segment to generate additional company features for inclusion in the set of company features; and
outputting the company features for use in processing queries related to the company.

2. The method of claim 1, wherein the member features comprise:
a numeric feature;
a binary feature; and
a recency feature.

3. The method of claim 2, wherein the company features comprise:
a count of active members in a member segment of the company;
a total count of members in the member segment of the company;
a ratio of the count of active members to the total count of members;
a first average calculated using the count of active members; and
a second average calculated using the total count of members.

4. The method of claim 3, wherein aggregating the company features by the member segment comprises:
aggregating, for the member segment within the company, the numeric feature into the count, the first average, the second average, the ratio, a sum for the numeric feature, and a median value of the numeric feature.

5. The method of claim 3, wherein aggregating the company features by the member segment comprises:
aggregating, for the member segment within the company, the binary feature into a sum of positive values in the binary feature, the count, the total count, the first average, the second average, and the ratio.

6. The method of claim 3, wherein aggregating the company features by the member segment comprises:
aggregating, for the member segment within the company, the recency feature into the count, the total count, the first average, the second average, the ratio, and a median value of the recency feature.

7. The method of claim 1, wherein using the one or more of the member features to identify a subset of the members for inclusion in the member segment comprises at least one of:
matching a member feature of a member to the member segment; and
inputting the one or more of the member features into a statistical model that classifies the member into the member segment.

8. The method of claim 1, wherein obtaining the member features comprises:
generating the member features along a first time interval that is faster than a second time interval for generating the company features.

9. The method of claim 1, wherein the members are further aggregated by an activity type.

10. The method of claim 9, wherein the activity type is at least one of:
page views;
profile views;
profile updates;
searches;
advertisements;
content interactions;
endorsements;
connections;
new member activity;
subscription funnel activity;
jobs;
recommendations;
invitations;
messages;
scores; and
address book activity.

11. The method of claim 1, wherein the member segments comprise at least one of:
employees of a company;
recruiters;
recruiter seats;
talent professionals;
core sales roles;
sales-related roles; and
decision makers.

12. An apparatus, comprising:
one or more processors; and
memory storing instructions that, when executed by the one or more processors, cause the apparatus to:
obtain member features for members of a social network, wherein the member features comprise a company;
obtain a definition of a member segment, wherein the definition comprises one or more of the member features;
identify a subset of the members for inclusion in the member segment using the one or more of the member features;
aggregate the member features by the company to generate a set of company features for the company;
aggregate the company features by the member segment to generate additional company features for inclusion in the set of company features; and
output the company features for use in processing queries related to the company.

13. The apparatus of claim 12, wherein using the one or more of the member features to identify a subset of the members for inclusion in the member segment comprises at least one of:
matching a member feature of a member to the member segment; and
inputting the one or more of the member features into a statistical model that classifies the member into the member segment.

14. The apparatus of claim 12, wherein the member features comprise:
a numeric feature;
a binary feature; and
a recency feature.

15. The apparatus of claim 14, wherein the company features comprise:
a count of active members in a member segment of the company;
a total count of members in the member segment of the company;
a ratio of the count of active members to the total count of members;
a first average calculated using the count of active members; and
a second average calculated using the total count of members.

16. The apparatus of claim 15, wherein aggregating the company features by the member segment comprises:
aggregating, for the member segment within a company, the numeric feature into the count, the first average, the second average, the ratio, a sum for the numeric feature, and a median value of the numeric feature.

17. The apparatus of claim 15, wherein aggregating the company features by the member segment comprises:
aggregating, for the member segment within the company, the binary feature into a sum of positive values in the binary feature, the count, the total count, the first average, the second average, and the ratio.

18. The apparatus of claim 15, wherein aggregating the company features by the member segment comprises:
aggregating, for the member segment within the company, the recency feature into the count, the total count, the first average, the second average, the ratio, and a median value of the recency feature.

19. A system, comprising:
an aggregation module comprising a non-transitory computer-readable medium storing instructions that, when executed, cause the system to:
obtain member features for members of a social network, wherein the member features comprise a company;
obtain a definition of a member segment, wherein the definition comprises one or more of the member features;
identify a subset of the members for inclusion in the member segment using the one or more of the member features;
aggregate the member features by the company to generate a set of company features for the company; and
aggregate the company features by the member segment to generate additional company features for inclusion in the set of company features; and
a management module comprising a non-transitory computer-readable medium storing instructions that, when executed, cause the system to output the company features for use in processing queries related to the company.

20. The system of claim 19, wherein the company features comprise:
a sum of numeric values in the member features;
a median of the numeric values;
a count of active members in a member segment;
a total count of members in the member segment;
a ratio of the count of active members to the total count of members;
a first average calculated using the count of active members; and
a second average calculated using the total count of members.
